(19) United States
(12) Patent Application Publication
(10) Pub. No.: US 2019/0278568 A1
(43) Pub. Date: Sep. 12, 2019

(54) RECORDING MEDIUM RECORDING GENERATION PROGRAM, INFORMATION PROCESSING APPARATUS, AND GENERATION METHOD

(71) Applicant: FUJITSU LIMITED, Kawasaki-shi (JP)

(72) Inventors: Naoki Kojima, Akashi (JP); Yasuo Sezaki, Akashi (JP); Akiko Matsumoto, Yokohama (JP); Yoshihiro Kimura, Kobe (JP); Yuji Aoki, Nagoya (JP); Makoto Ikeyama, Nagoya (JP); Shinji Haseo, Toyoake (JP)

(73) Assignee: FUJITSU LIMITED, Kawasaki-shi (JP)

(21) Appl. No.: 16/263,107

(22) Filed: Jan. 31, 2019

(30) Foreign Application Priority Data
Mar. 9, 2018 (JP) 2018-043492

(51) Int. Cl. G06F 8/10; G06F 9/48; G06F 8/20

(52) U.S. Cl. CPC G06F 8/10; G06F 8/20; G06F 9/4843

(57) ABSTRACT

A non-transitory computer-readable recording medium recording a generation program for causing a computer to execute processing includes: referring to a storage which identifiably stores whether or not an input value is specified for each of a plurality of programs corresponding to a plurality of processing included in a workflow to be created; specifying a first program in which the input value is specified and a second program in which the input value is not specified from among the plurality of programs; determining whether or not the input value of the second program is estimated based on the input value of the first program and a positional relation in the workflow between the specified first program and second program; and setting the input value of the first program as the input value of the second program when determining that the input value of the second program is estimated.

### CROSS-REFERENCE TO RELATED APPLICATION

This application is based upon and claims the benefit of priority of the prior Japanese Patent Application No. 2018-43492, filed on Mar. 9, 2018, the entire contents of which are incorporated herein by reference.

### FIELD

The embodiment discussed herein is related to a generation program, an information processing apparatus, and a generation method.

### BACKGROUND

In recent years, the Runbook Automation (RBA) technology which automates an operation work of a business system has attracted attention.

Related art is disclosed in International Publication Pamphlet No. 2014/136210 and Japanese Laid-open Patent Publication No. 2017-33388.

### SUMMARY

According to an aspect of the embodiments, a non-transitory computer-readable recording medium recording a generation program for causing a computer to execute processing includes: referring to a storage which identifiably stores whether or not an input value is specified for each of a plurality of programs corresponding to a plurality of processing included in a workflow to be created; specifying a first program in which the input value is specified and a second program in which the input value is not specified from among the plurality of programs; determining whether or not the input value of the second program is estimated based on the input value of the first program and a positional relation in the workflow between the specified first program and second program; and setting the input value of the first program as the input value of the second program when determining that the input value of the second program is estimated.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining an example of a configuration of a generation device;

FIG. 2 is a flowchart for explaining an example of a workflow generation method;

FIG. 3 is a flowchart for explaining an example of learning processing;

FIG. 4 is a diagram for explaining an example of the learning processing;

FIG. 5 is a diagram for explaining an example of operation information extraction processing;

FIG. 6 is a diagram for explaining an example of a method for generating operation design information;

FIG. 7 is a flowchart for explaining an example of a method for extracting an input value;

FIG. 8 is a diagram for explaining an example of an input value table;

FIG. 9 is a diagram for explaining an example of the operation design information;

FIG. 10 is a diagram for explaining an example of the operation design information;

FIG. 11 is a diagram for explaining an example of determination processing;

FIG. 12 is a diagram for explaining an example of the operation design information;

FIG. 13 is a diagram for explaining an example of the operation design information;

FIG. 14A is a flowchart for explaining an example of a method for setting the input value;

FIG. 14B is a flowchart for explaining an example of the method for setting the input value; and

FIG. 15 is a diagram for explaining an example of a hardware configuration of the generation device.

### DESCRIPTION OF EMBODIMENTS

For example, when the RBA technology is applied, many works which have been performed by an operator according to an operation procedure manual are automated. Therefore, various effects can be expected such as reduction in an operation load, reduction in human errors, and reduction in operation cost. In a case where the operation by the operator using the operation procedure manual is switched to the operation using the RBA technology, a workflow definition file (workflow) compatible with the RBA technology is created. The workflow is created by using a dedicated development environment (editor). In this case, the operator arranges various operation handling components which have been set to the editor in advance according to an operation procedure described in the operation procedure manual to create the workflow.

If the operator creates the workflow, operating costs such as personnel expenses and man-hours to create the workflow are generated. In view of this, to assist the creation of the workflow, an operation flow creation assisting device has been proposed which associates an operation with a component based on a comparison result between an operation name of an operation and a component name included in the operation work.

In addition, a method for extracting input information by using an input template for each piece of operation information extracted from operation procedure information and makes a computer execute processing for selecting an automatic operation component corresponding to the operation procedure information so to as reduce unknown input information has been proposed.

When the workflow is created, not only is the operation in the operation procedure associated with the operation handling component, but also the operation handling component is associated with an input value input to the operation handling component. It is difficult to automatically associate the operation handling component with the input value, and the operator manually associates the operation handling component with the input value while confirming a content of the operation procedure manual. Even if the method using the input template is used, in a case where a format of the operation procedure manual is different from a format of the input template, extraction of the input value fails. Therefore, it is difficult to automatically generate the workflow from the operation procedure manual.

For example, a workflow may be generated from an operation procedure manual automatically.

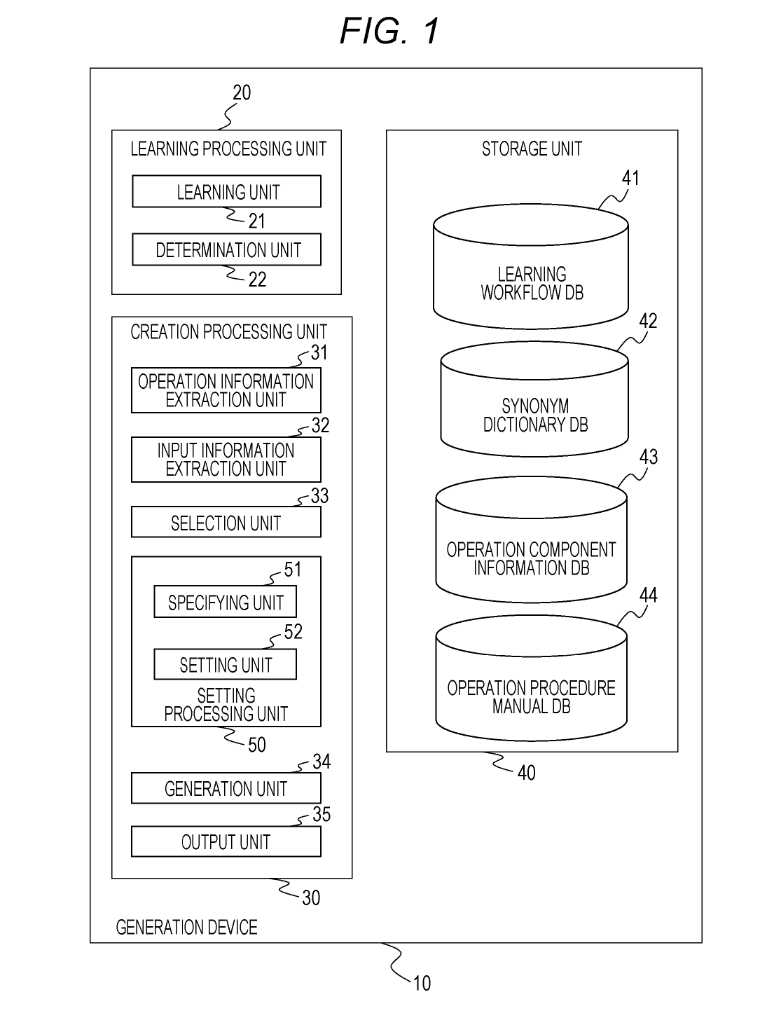

Hereinafter, an embodiment will be described with reference to the drawings. FIG. 1 is a diagram for explaining an example of a configuration of a generation device 10. The generation device 10 includes a learning processing unit 20, a creation processing unit 30, and a storage unit 40. The storage unit 40 holds a learning workflow database 41, a synonym dictionary database 42, an operation component information database 43, and an operation procedure manual database 44. In addition to the databases, the storage unit 40 stores data obtained by processing by the learning processing unit 20 and the creation processing unit 30 and the like. The database is written as a DB.

The learning workflow database 41 is a database in which learning data to be used by a learning unit 21 is recorded. A workflow which has been already generated (workflow in the past and the like) is used as the learning data. The learning workflow database 41 may include information regarding a system which operates the workflow. For example, in a case where a workflow to be the learning data is selected in accordance with the type of the operation procedure manual to be processed, the learning workflow database 41 may include information to be a selection reference. The operation procedure manual database 44 records the operation procedure manual to be processed. The operation procedure manual is a file in which a content of processing is described so that an operator can read the content and execute operation processing. The operation procedure manual may be generated, for example, as a text file. The synonym dictionary database 42 associates an expression used when words described in the operation procedure manual is normalized with a synonym which is normalized to the expression.

The operation component information database 43 records a name of an operation handling component, information for specifying a type of an input value to be input to the operation handling component, and the like. The operation handling component (operation component) is a program used to execute processing in the workflow.

The learning processing unit 20 includes the learning unit 21 and a determination unit 22. The learning unit 21 machine-learns on a relation between a distance between the plurality of operation handling components and the input value input to each operation handling component by using the workflow recorded in the learning workflow database 41. Hereinafter, the machine learning may be simply referred to as learning.

The determination unit 22 determines whether there is a high possibility that an input value relative to a preceding operation handling component matches an input value relative to a subsequent operation handling component by using the learning result of the learning unit 21. In the following description, there is a case where the information for specifying the type of the input value to be input to the operation handling component is described as “input information”. For example, it is assumed that the operation handling component be a program for creating a file and create a file having a file name input to the operation handling component. In a case where test.txt is input as a file name to be created, the input value is “test.txt”, and the input information is “the name of the file to be created”.

The creation processing unit 30 includes an operation information extraction unit 31, an input information extraction unit 32, a selection unit 33, a generation unit 34, an output unit 35, and a setting processing unit 50. The operation information extraction unit 31 extracts an expression regarding an operation for each work item number from the operation procedure manual. The input information extraction unit 32 extracts the expression which may be an input value of an operation component from the operation procedure manual together with a work item number in which the expression appears and associates the extracted expression and work item number with attribute information of the expression. The selection unit 33 records the extracted expression regarding the operation in operation design information in association with the operation handling component. At this time, the selection unit 33 may refer to the operation component information database 43 as appropriate. The generation unit 34 generates a workflow by using a processing result of the setting processing unit 50. The output unit 35 outputs the generated workflow.

The setting processing unit 50 includes a specifying unit 51 and a setting unit 52. The specifying unit 51 specifies input information to be a target of determination processing by the determination unit 22. The setting unit 52 sets the input value to the operation handling component. Details of processing executed by the creation processing unit 30 and the setting processing unit 50 will be described later.

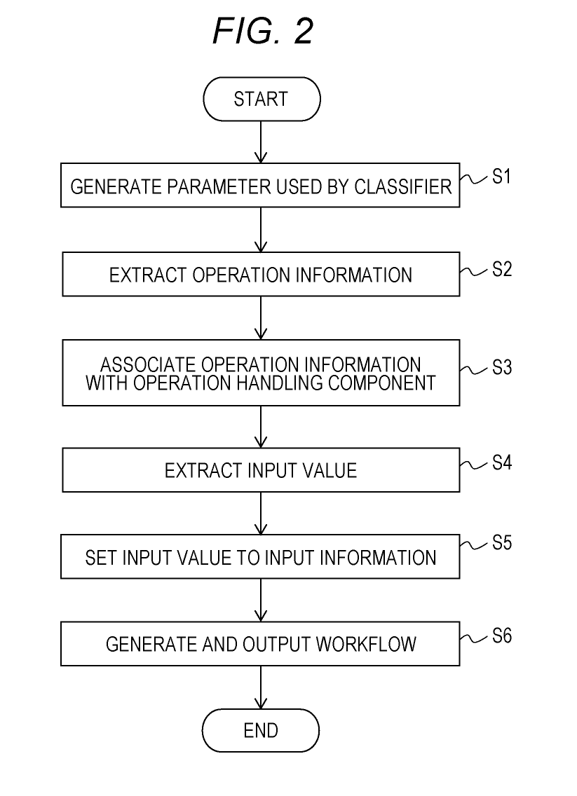

FIG. 2 is a flowchart for explaining an example of a workflow generation method. Although an outline of the workflow generation method will be described with reference to the flowchart in FIG. 2, details of processing in each step will be described later.

The learning unit 21 learns a workflow in the past to generate a parameter which is used when the determination unit 22 operates as a classifier (step S1). The operation information extraction unit 31 reads the operation procedure manual to be processed from the operation procedure manual database 44 and extracts an expression indicating an operation included in the operation procedure manual as operation information (step S2). With reference to the operation component information database 43, the selection unit 33 associates the extracted operation information with each operation handling component and records the obtained result in the operation design information (step S3). At this time, the selection unit 33 specifies the type of the information input to each operation handling component associated with the operation information as the input information and records the specified information in the operation design information. The input information extraction unit 32 extracts a description indicating the input value included in the operation procedure manual as an input value (step S4). The setting unit 52 sets the input value to each piece of the input information recorded in the operation design information (step S5). At this time, the setting unit 52 uses a result of determination whether the possibility that an input value of certain piece of the input information becomes the same as the input value of the other piece of the input information is high made by the determination unit 22 as appropriate. The determination unit 22 executes the determination processing by using the parameter generated in step S1. When the setting of the input value by the setting unit 52 has been completed, the generation unit 34 generates a workflow, and the output unit 35 outputs the generated workflow (step S6).

In FIG. 2, the processing in step S1 may be executed at any timing before the processing in step S5 is executed. For example, the processing in step S1 may be executed before the processing subsequent to step S2 as preprocessing and may be executed after step S4. In addition, the processing in step S4 may be executed before steps S2 and S3.

<Learning Processing>

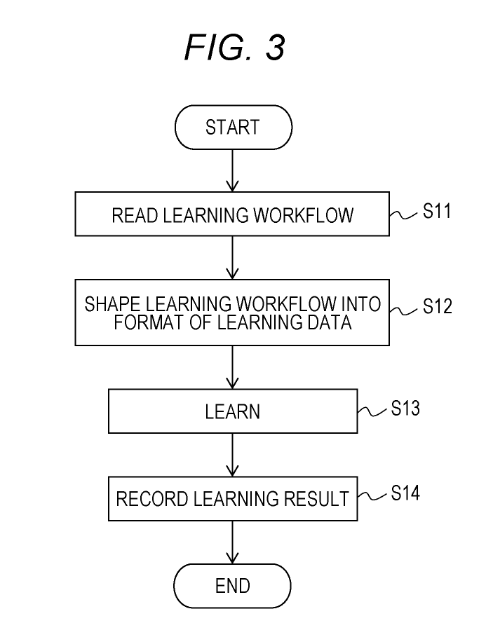

FIG. 3 is a flowchart for explaining an example of the learning processing. The learning unit 21 reads a learning workflow from the learning workflow database 41 (step S11). At this time, the learning unit 21 may use a part of the workflow recorded in the learning workflow database 41 for learning and may use all the workflows recorded in the learning workflow database 41 for learning. For example, an operator may select the workflow used for learning according to the content of the operation procedure manual to be processed and set the selected workflow to the learning unit 21. The learning unit 21 shapes the learning workflow into a format of the learning data (step S12). In step S12, the learning unit 21 extracts information used for the learning processing such as the input information of the operation handling component, the distance between the operation handling components, and the like from the learning workflow and uses the extracted information as the learning data. The learning unit 21 machine-learns the obtained learning data by a classifier (step S13). The classifier included in the learning unit 21 is an arbitrary classifier which can perform machine learning. The learning unit 21 records the information obtained by the machine learning by the classifier in the storage unit 40 as a learning result (step S14). Note that step S14 is optional, and the processing may be modified so as not to perform step S14. For example, instead of the processing in step S14, the learning unit 21 may set the parameter, which is used when the determination using the learning result is made, to the determination unit 22.

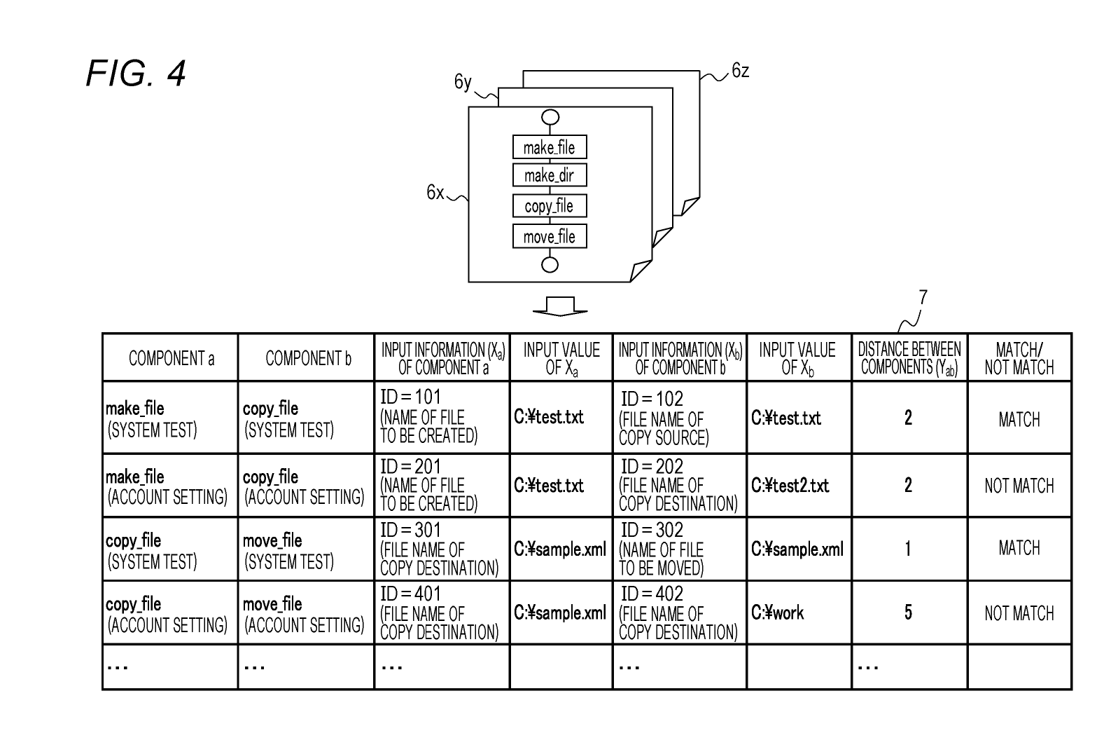

FIG. 4 is a diagram for explaining an example of the learning processing. With reference to FIG. 4, an example of the processing executed in steps S12 and S13 in FIG. 3 will be described in detail. In the example in FIG. 4, it is assumed that workflows 6x to 6z be read by the learning unit 21 as workflows used for learning. The workflow 6x includes four operation handling components, i.e., make_file, make_dir, copy_file, and move_file, in this order. It is assumed that the workflow 6x include input information used by each operation handling component for processing. The learning unit 21 machine-learns a positional relation between these operation handling components and the input information input to each operation handling component from the workflow 6x. The positional relation between two operation handling components is the number of operation handling components recorded in the workflow 6 from one operation handling component to the other operation handling component. In the following description, the positional relation between the operation handling components may be referred to as “a distance between the operation handling components”. For example, in the workflow 6x, since the first operation handling component after the operation handling component “make_file” is make_dir, a distance between make_file and make_dir is one. On the other hand, the second operation handling component from the operation handling component “make_file” is copy_file. Therefore, a distance between make_file and copy_file is two.

As illustrated in learning data 7 in FIG. 4, since there is a case where the plurality of input values is input to the single operation handling component, each input value is associated with input information indicating the type of the input value. As the input information, identification information (ID) for uniquely specifying a combination of the operation handling component and the type of the input value is used.

As illustrated in the learning data 7 in FIG. 4, the above described distance is recorded in association with input information and input values of components a and b. In a case where the input value of the component a is equal to the input value of the component b, the input information and the input values of the components a and b are associated with “match”. In a case where the input value of the component a is not equal to the input value of the component b, the input information and the input values of the components a and b are associated with “not match”.

The learning unit 21 machine-learns the learning data 7 as an input and generates a classifier. The classifier is also referred to as a learned model.

<Extraction of Operation Information>

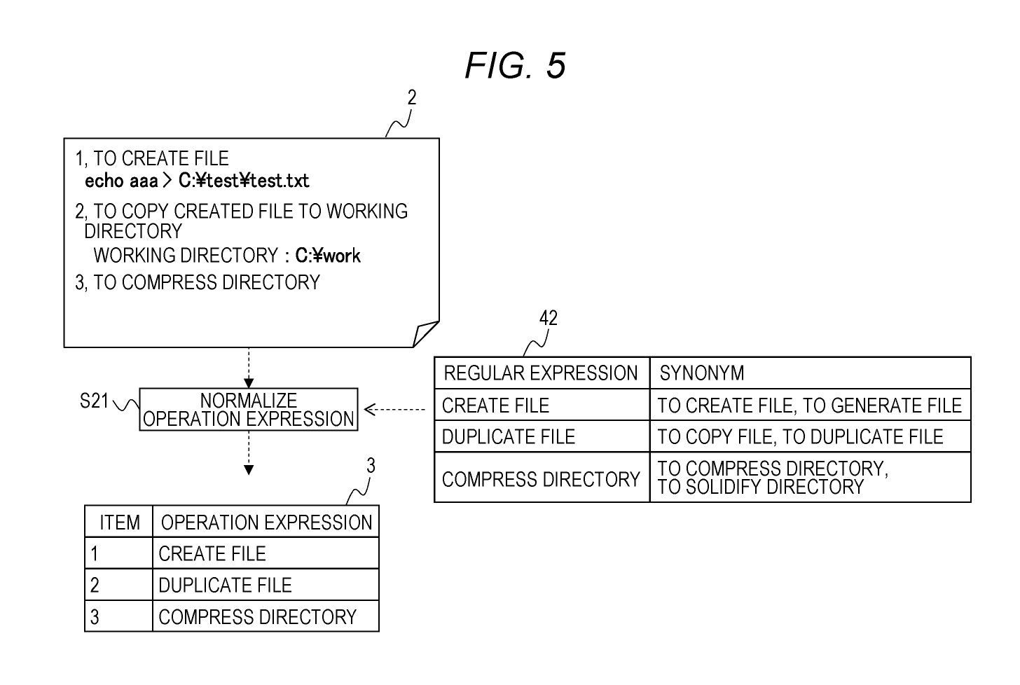

FIG. 5 is a diagram for explaining an example of operation information extraction processing. With reference to FIG. 5, an example of the processing in step S2 in FIG. 2 will be described. An operation procedure manual 2 in FIG. 5 is an example of an operation procedure manual described as text data. In the operation procedure manual 2 illustrated in FIG. 5, an item number and a procedure corresponding to each item number are described. The item number is a number indicating an order of each procedure.

The operation information extraction unit 31 extracts an expression regarding operation handling in association with the item number from each working item described in the operation procedure manual 2. Hereinafter, the expression regarding the operation handling in the operation procedure manual 2 may be referred to as “operation expression”. The operation information extraction unit 31 refers to the synonym dictionary database 42 to process the extracted operation expression.

In the synonym dictionary database 42, an expression (regular expression) used at the time of normalization is associated with a synonym which is replaced with the regular expression. In the example in FIG. 5, both of the words of “to create a file” and the words of “to create a file” are synonyms of a regular expression of “create a file”. Similarly, both of words “to copy a file” and words “to duplicate” are synonyms of a regular expression of “duplicate a file”. Both words of “to compress a directory” and a word of “solidify” are synonyms of a regular expression of “compress a directory”.

The operation information extraction unit 31 replaces the operation expression extracted from the operation procedure manual 2 with the regular expression included in the synonym dictionary database 42 to normalize the operation expression (step S21). For example, the operation information extraction unit 31 extracts the operation expression of “to generate a file” from the item=1. The operation information extraction unit 31 refers to the synonym dictionary database 42 to replace the operation expression extracted from the item=1 with the regular expression of “create a file”. By executing similar processing on the other items, the operation information extraction unit 31 generates an item-number-classified operation information 3 illustrated in FIG. 5.

<Generation of Operation Design Information>

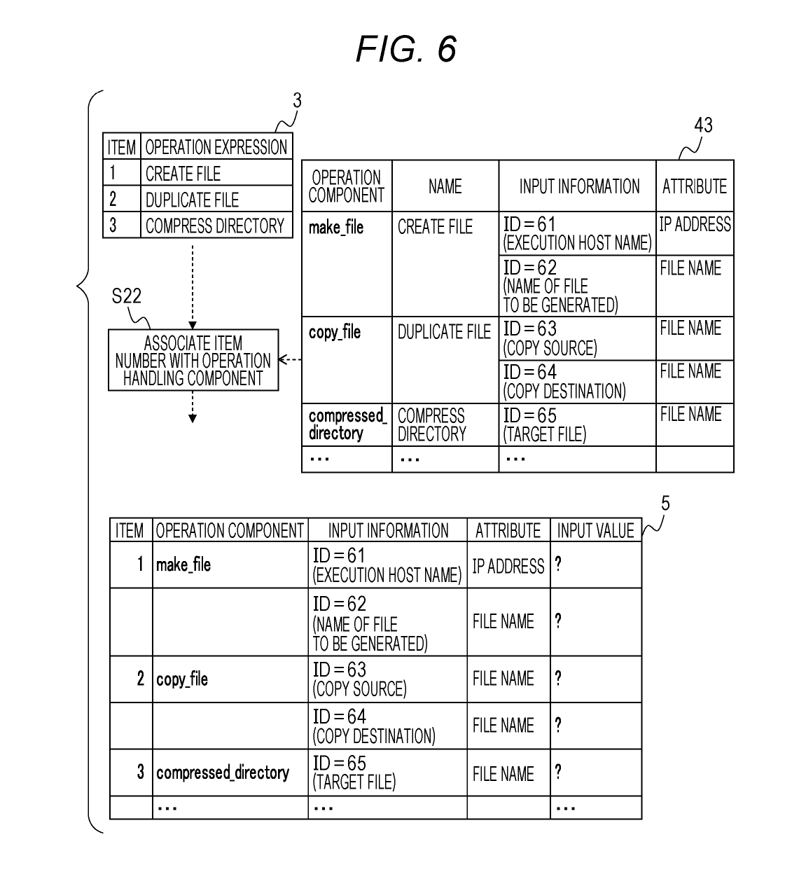

FIG. 6 is a diagram for explaining an example of a method for generating operation design information 5. An example of the processing in step S3 in FIG. 2 will be described with reference to FIG. 6. The selection unit 33 refers to the operation component information database 43 to determine an operation handling component corresponding to each operation in the item-number-classified operation information 3.

In the operation component information database 43, the name of the operation handling component, the input information, and the attribute are recorded in association with the operation handling component. The name of the operation handling component is uniquely associated with the regular expression indicating processing executed by the operation handling component. In the example in FIG. 6, as the name of the operation handling component, the regular expression indicating the processing executed by the operation handling component is used. The input information is identification information indicating the type of the information to be input to the operation handling component at the time of the processing of the operation handling component. For example, a first entry of the operation component information database 43 indicates that information identified by ID=61 and information identified by ID=62 are input relative to the operation handling component “make_file”. It is assumed that ID=61 be information identifying an execution host name input to make_file and that ID=62 be information identifying a name of a file to be generated input to make_file. In the attribute, a data type received as the input information for each input information is recorded. For example, in the first entry of the operation component information database 43, an attribute corresponding to ID=61 (execution host) is an IP address, and an attribute corresponding to ID=62 (name of file to be generated) is a file name.

The selection unit 33 searches the operation component information database 43 for an operation expression registered to each item of the item-number-classified operation information 3 as a key, and records the operation handling component and information obtained by the search in the operation design information 5 in association with the item number (step S22). For example, in the item-number-classified operation information 3 in FIG. 6, “create a file” is obtained as the operation expression of which the item number=1. Therefore, the selection unit 33 searches the operation component information database 43 for the words of “create a file” as a key, and records the obtained value and the obtained operation handling component in the operation design information 5 in association with the item number=1. By similarly executing the processing on the other items, the operation design information 5 illustrated in FIG. 6 is generated. At the stage where the operation by the selection unit 33 has been completed, input values applied to all the input information included in the operation design information 5 are not set.

<Method for Extracting Input Value>

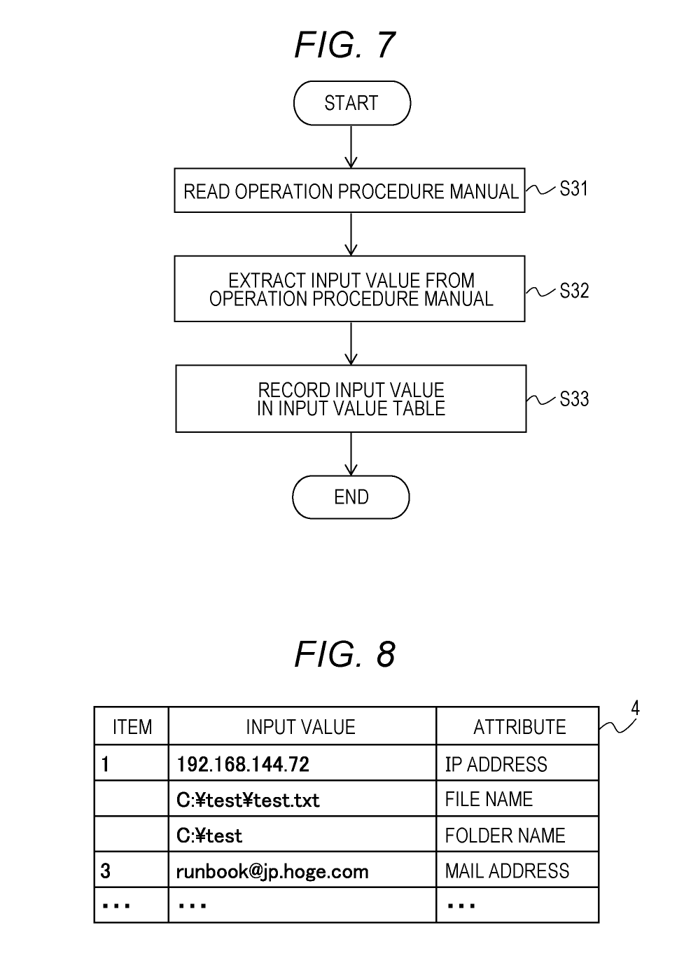

FIG. 7 is a flowchart for explaining an example of a method for extracting the input value. An example of the processing in step S4 in FIG. 2 will be described with reference to FIG. 7. The input information extraction unit 32 reads the operation procedure manual 2 (step S31). The input information extraction unit 32 extracts an input value from the operation procedure manual 2 (step S32). The input information extraction unit 32 may hold a regular expression table in advance. The regular expression table is an arbitrary table which can be used to extract the input value which can specify the regular expression such as a file path and a mail address. The input information extraction unit 32 extracts the input value from the operation procedure manual 2 by using the regular expression table. The input information extraction unit 32 may specify the input value and the attribute from data of the operation procedure manual 2 by using a named entity extraction method which is one of natural language processing techniques. Thereafter, the input information extraction unit 32 records the extracted input value in the input value table, together with the number of the item in which the input value has appeared (step S33). At this time, the input information extraction unit 32 records the input value and the attribute of the input value in the input value table.

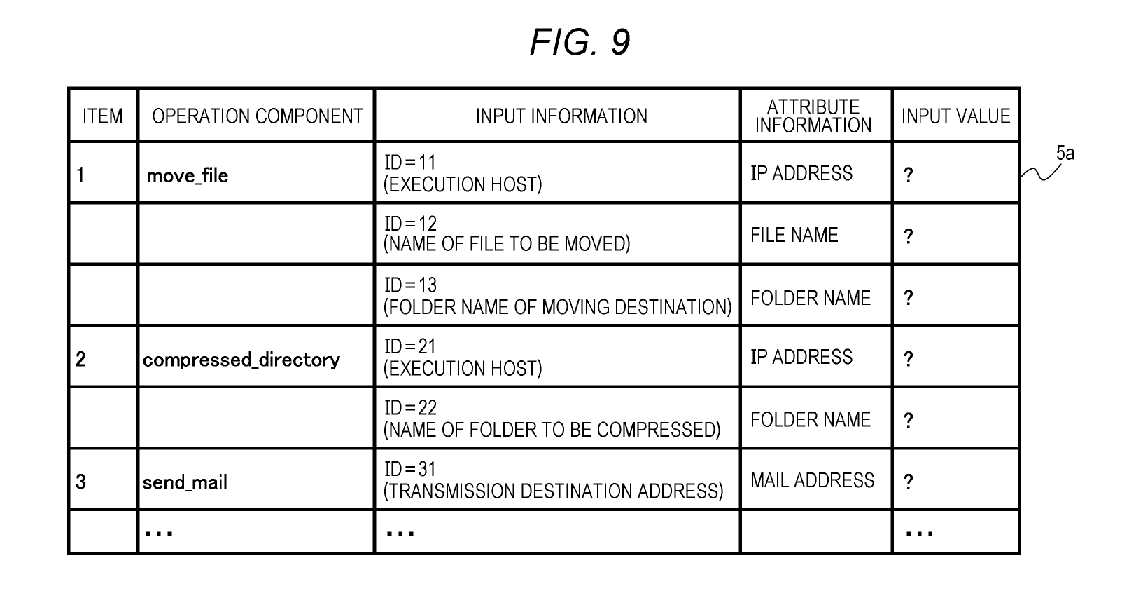

FIG. 8 is a diagram for explaining an example of an input value table 4. FIG. 8 is an example of the input value table 4 in a case where an operation procedure manual 2 different from the operation procedure manual 2 illustrated in FIG. 5 is used. In the input value table 4, a number of the item, the input value, and the attribute are associated with each other. The number of the item is a number of an item in which each input value has been described in the operation procedure manual 2. The attribute indicates a data type of the input value.

<Method for Setting Input Value>

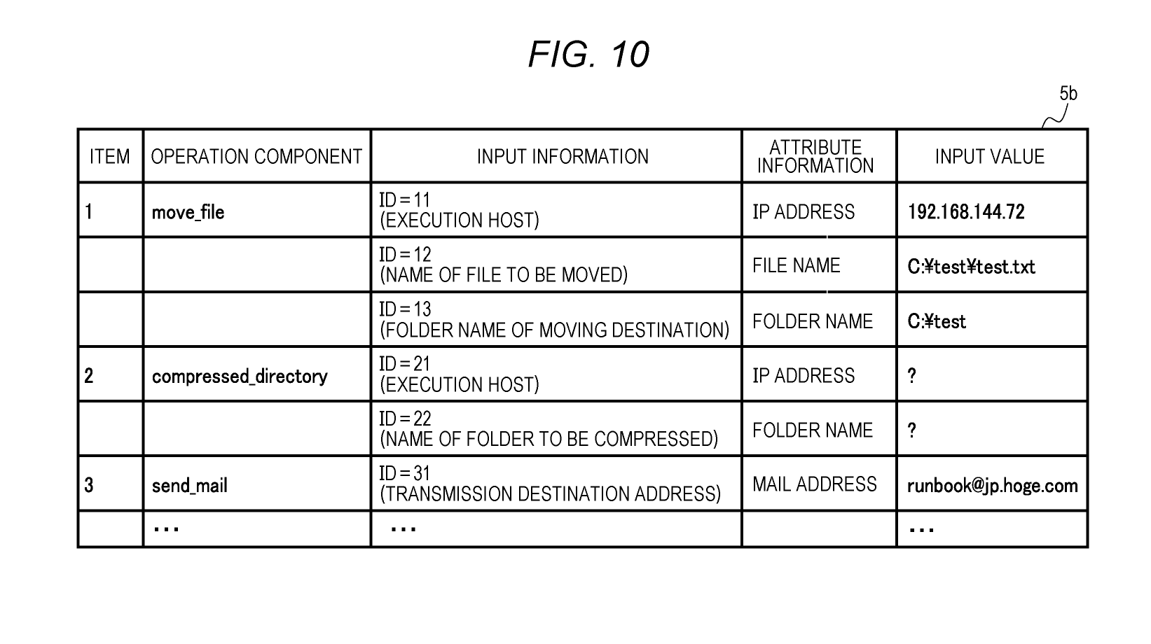

FIG. 9 is a diagram for explaining an example of the operation design information 5. An operation design information 5a illustrated in FIG. 9 is generated by processing similar to the processing described with reference to FIGS. 4 to 6. Hereinafter, an example of a method for setting the input value will be described by using a case where the input value table 4 illustrated in FIG. 8 and the operation design information 5a illustrated in FIG. 9 are obtained as an example.

The setting unit 52 sets the input value in the input value table 4 as an input value to the operation handling component in the operation design information 5 by using following two determination criteria.

Criterion 1) In a case where the attribute of the input value is the same as the attribute of the input information input to the operation handling component and the item number associated with the operation handling component matches the item number in which the input value has appeared, the input information of the operation handling component is set as the input value.

Criterion 2) In a case where the input information can be estimated based on information on a combination of the order of the operation handling components obtained by learning the workflow and the input information of each operation handling component, a value input to the operation handling component is set by using the estimation result. Hereinafter, an example of setting of the input value will be described as dividing the method into two methods, i.e., a method for setting the input value by using the criterion 1 and a method for setting the input value by using the criterion 2.

(1) Method for Setting Input Value by Using Criterion 1

In the setting of the input value by using the criterion 1, the setting unit 52 selects an operation handling component to be processed from among the operation handling components described in the operation design information 5a (FIG. 9). It is assumed that move_file be selected as the processing target. The setting unit 52 recognizes that an attribute of input information identified by ID=11 of the information input to move_file is an IP address. Next, the setting unit 52 searches the input value table 4 for information in which the “IP address” is set to the attribute. In the example in FIG. 8, the setting unit 52 specifies “192.168.144.72” as an input value of which the attribute is the IP address.

The setting unit 52 determines whether an item number associated with the operation handling component to be processed matches an item number associated with the input value specified from the input value table 4. In this example, an item number associated with move_file is one, and an item number associated with the input value “192.168.144.72” specified from the input value table 4 is also one. Therefore, the setting unit 52 sets the input value “192.168.144.72” as the value of the input information identified by ID=11 of the information input to move_file.

Similarly, the setting unit 52 recognizes that the attribute of the input information identified by ID=12 of the input information to move_file is a file name. The setting unit 52 extracts “C:\test\test.txt” from the input value table 4 as the input value of which the attribute is the file name. Since both of the operation handling component move_file to be an input destination of ID=12 and the input value “C:\test\test.txt” are associated with the item number=1, the setting unit 52 sets C:\test\test.txt as the value of the input information of ID=12.

Next, an example in a case where the setting unit 52 executes processing on an operation handling component (compressed_directory) of which an item number=2 will be described. The setting unit 52 recognizes that an attribute of input information identified by ID=21 of input information to compressed_directory is an IP address. The setting unit 52 specifies “192.168.144.72” as an input value of which the attribute is the IP address from the input value table 4. However, in this example, the item number corresponding to compressed_directory is two. Whereas, the item number associated with the specified input value is one. Since the item number of the operation handling component to be the input destination does not match the item number in which the input value has appeared, the setting unit 52 does not set an input value to the input information identified by ID=21. In addition, regarding other input information, the setting unit 52 associates the input value with the input information according to the criterion 1.

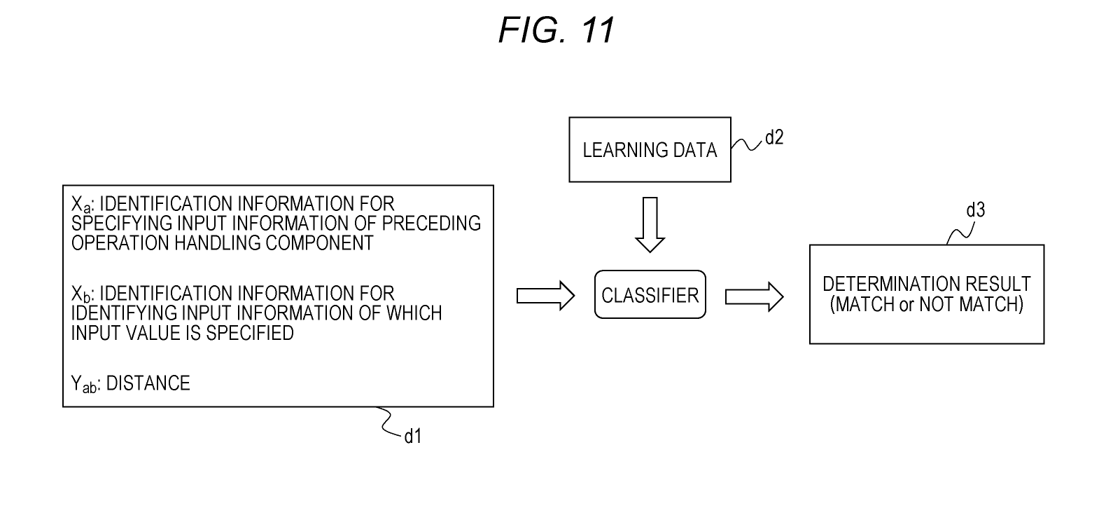

FIG. 10 illustrates an example of the operation design information 5 obtained by executing the processing using the criterion 1 by the setting unit 52. Information indicated by a thick line in operation design information 5b in FIG. 10 is information set by the processing using the criterion 1. At a stage illustrated in the operation design information 5b, information input to the operation handling component of which the item number=2 is not set.

(2) Method for Setting Input Value by Using Criterion 2

Regarding input values which are not set even when the setting processing using the criterion 1 has been executed, setting processing using the criterion 2 is executed. In the setting processing using the criterion 2, the specifying unit 51 specifies input information to be a target of the determination processing. The specifying unit 51 specifies an operation handling component (second operation handling component) using an input value to be set. In addition, the specifying unit 51 specifies an operation handling component (first operation handling component) to which the input value has been already set. In the following example, a case where the first operation handling component is selected from among the operation handling components on which the processing is executed prior to the second operation handling component will be described as an example. For example, it is assumed that the specifying unit 51 determine the input information identified by ID=21 in the operation design information 5b (FIG. 10) as a setting target of the input value. The specifying unit 51 sets compressed_directory to be the input destination of the input information identified by ID=21 as the second operation handling component. The specifying unit 51 specifies move_file as the first operation handling component which is an operation handling component processed prior to the second operation handling component and has the input information to which the input value has been set. In addition, since move_file to be the first operation handling component is associated with three pieces of input information identified by each of IDs=11 to 13, the specifying unit 51 specifies the input information of IDs=11 to 13 as a candidate used for the determination processing. The specifying unit 51 further specifies a positional relation between the specified first operation handling component and second operation handling component. The positional relation (distance) between the first operation handling component and the second operation handling component is expressed by the number of operation handling components used after the first operation handling component and before the second operation handling component. The distance between the first operation handling component and the second operation handling component is the same value as a difference between the item numbers allocated to the respective operation handling components. In the example of the operation design information 5b, the first operation handling component is move_file of which the item number=1, and the second operation handling component is compressed_directory of which the item number=2. Therefore, the distance between the first operation handling component and the second operation handling component is one.

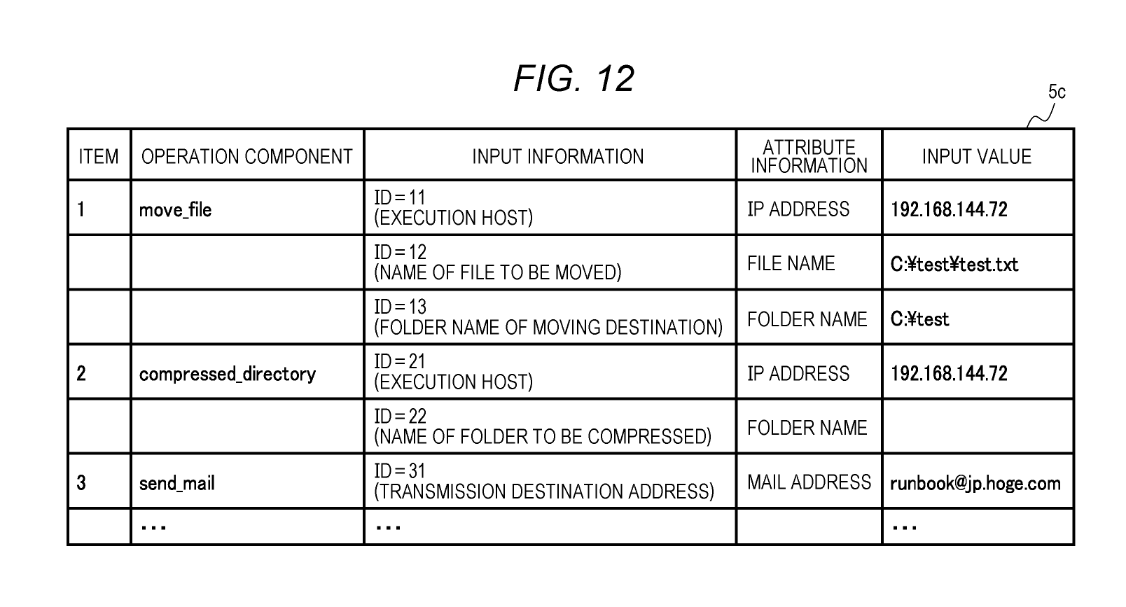

FIG. 11 is a diagram for explaining an example of the determination processing. When the specifying unit 51 ends the specifying processing, the determination unit 22 determines whether an input value can be estimated based on the positional relation between the operation handling components to which the respective pieces of the input information are input and a combination of the pieces of the input information of the operation handling components regarding two pieces of input information to be determined. At this time, the determination unit 22 operates as a classifier F (Xₐ, X_{b}, Y_{ab}) which executes the determination processing by using the learning result (classifier) of the machine learning by the learning unit 21. As illustrated in FIG. 11, input data d1 to the classifier is Xₐ, X_{b}, and Y_{ab}. The data Xₐ is identification information for specifying the input information of the first operation handling component. In a case where there is a plurality of pieces of input information of the first operation handling component, the data Xₐ is identification information for identifying the input information to be a target of the determination processing of the input information of the first operation handling component. The data X_{b} is identification information for identifying the input information which is a setting target of the input value of the input information of the second operation handling component. The data Y_{ab} is the distance between the first operation handling component and the second operation handling component.

In a case where the input data d1 is input to the classifier F, the determination unit 22 determines whether the input data d1 is classified into “match” or “not match” the tendency indicated by the classifier F. The learned model is generated by machine-learning learning data d2 (learning data 7 described above). Accordingly, it may be said that the learned model is a conversion parameter to convert the identification information for specifying the input information to the first operation handling component, the identification information for specifying the input information to the second operation handling component, and the distance between the first operation handling component and the second operation handling component into the determination result. The determination unit 22 generates the result obtained by making determination on the input data d1 by using the classifier as a determination result d3.

Since the input information identified by ID=21 of the input information to compressed_directory is the setting target of the input value, X_{b} is ID=21. On the other hand, it is assumed that ID=11 of the input information to move_file which is the first operation handling component be selected as a target of the determination processing. In this case, since Y_{ab} is a distance from move_file to compressed_directory, Y_{ab} is one. When these values are input to the determination unit 22, the determination unit 22 outputs the determination result d3 based on the learned model. In this example, it is assumed that the determination result by the determination unit 22 be “match”. The setting unit 52 sets an input value to be set to the input information identified by ID=21 as a value same as the value set to the input information identified by ID=11.

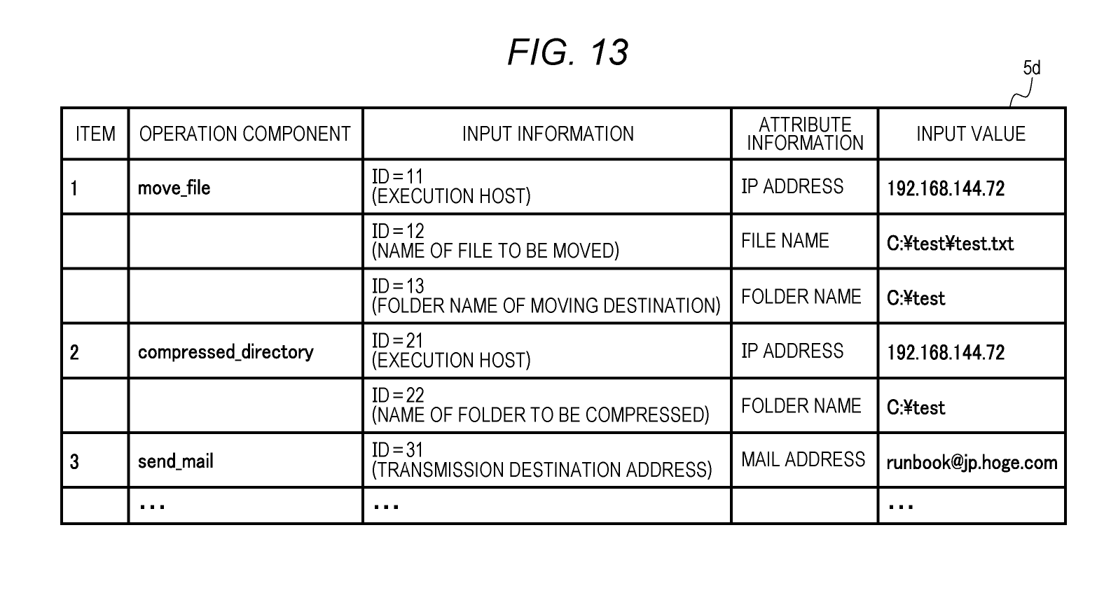

FIG. 12 is a diagram for explaining an example of operation design information. In the example in FIG. 12, the setting unit 52 sets “192.168.144.72” which is the same as the value set to the input information identified by ID=11 as information of the execution host (ID=21) input to compressed_directory. Therefore, the operation design information 5b (FIG. 10) is updated to an operation design information 5c illustrated in FIG. 12.

Next, it is assumed that the specifying unit 51 specify input information identified by ID=22 of the input information to compressed_directory as a setting target of the input value. In addition, it is assumed that the specifying unit 51 select input information of ID=13 input to move_file as the input information of the first operation handling component used for the determination processing. Then, the values input to the classifier are as follows.

Xₐ: ID=13

X_{b}: ID=22

Y_{ab}: 1

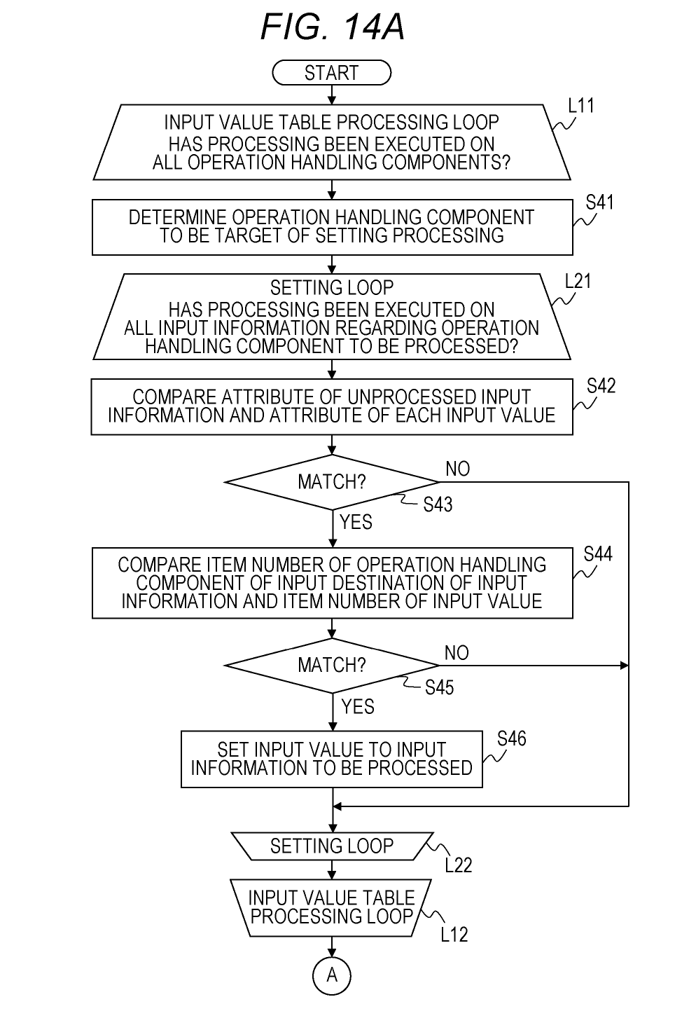

It is assumed that the determination result at the time when the determination unit 22 has made determination by using the learned model as a classifier be “match”. Then, the setting unit 52 sets an input value “C:\test” set to the input information identified by ID=13 as a setting value of input information identified by ID=22. Therefore, the operation design information 5c (FIG. 12) is updated as operation design information 5d illustrated in FIG. 13. As described with reference to FIGS. 10 to 13, since the generation device 10 makes determination by using the learned model, for example, there is a case where an input value can be set regarding an operation procedure manual 2 in which an input value of an operation handling component in some items is not extracted from the description in the operation procedure manual 2. For example, as described below, there is a case where a file name to be the input value is not specified in some items in the operation procedure manual 2 and only an item number in which the input file is generated is described.

Item number 2: Compress a working directory. Compressed file: C:\result.zip

Item number 3: Transfer file in 2 to a backup server

In this case, the input information extraction unit 32 does not extract a name of the file to be transferred in the processing of which the item number=3 as an input value from the description in the operation procedure manual. Therefore, in the processing using the criterion 1, input information to the operation handling component of which the item number is three is not set. It is assumed that the learning unit 21 learn that a subsequent operation handling component (second component) of which a distance from an operation handling component (first component) which compresses a directory is one executes transfer processing in the workflow in the past. It is assumed that the learning unit 21 learn that an input value input to the first component as a compressed file name matches an input value input to the second component as a target of the transfer processing in the workflow in the past. In this case, it is registered in the learned model that the input value input to the first component as the compressed file name matches the input value input to the second component as the target of the transfer processing, and a distance between the first component and the second component is also registered in the learned model. Therefore, the determination unit 22 positively determines a possibility that the input value for specifying a target of the transfer processing relative to the operation handling component which executes processing of which the item number is three matches the compressed file name input to the operation handling component which executes processing of which the item number is two by using the learned model. Based on this determination, the setting unit 52 can set “C:\result.zip” which is the same as the compressed file name input to the operation handling component which executes the processing of which the item number is two as the input information for specifying the target of the transfer processing of the operation handling component which executes the processing of which the item number is three.

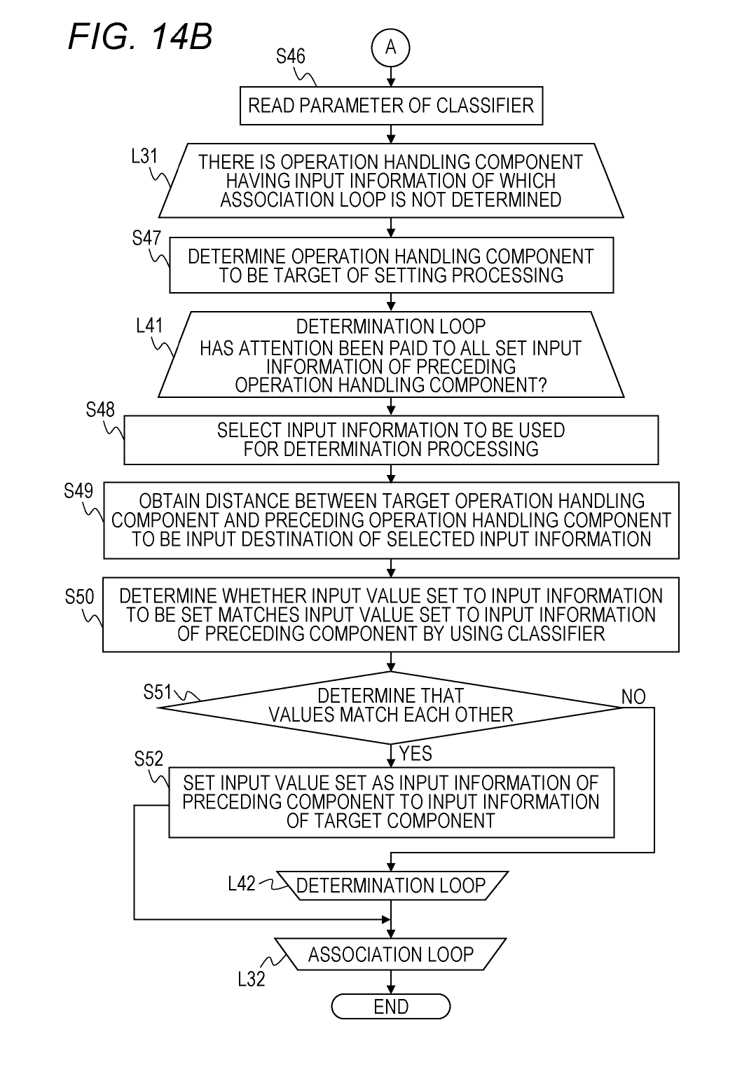

FIGS. 14A and 14B are flowcharts for explaining an example of a method for setting the input value. In the examples in FIGS. 14A and 14B, a case where the learning unit 21 stores the generated learned model in the storage unit 40 as a parameter and the determination unit 22 reads the parameter when executing processing is described as an example. However, FIGS. 14A and 14B are examples of the processing, and a timing when the parameter to use the learned model is set to the determination unit 22 may be optionally changed. In addition, processing in steps S44 and S45 may be executed before processing in steps S42 and S43.

When the operation design information 5 to which the input value is not set is generated, loop processing sandwiched between loop ends L11 and L12 is executed. Hereinafter, there is a case where the loop processing sandwiched between the loop ends L11 and L12 is referred to as an “input value table processing loop”. The setting unit 52 determines whether processing has been executed on all the operation handling components (loop end L11). In a case where the processing is not executed on all the operation handling components, the setting unit 52 determines the operation handling component to be a target of the input value setting processing (No in loop end L11, step S41).

Next, loop processing sandwiched between loop ends L21 and L22 is executed. Hereinafter, there is a case where the loop processing sandwiched between the loop ends L21 and L22 is referred to as a “setting loop”. The setting unit 52 determines whether all the input information has been processed regarding the operation handling component to be processed (loop end L21). In a case where all the input information has not been processed regarding the operation handling component to be processed, the setting unit 52 compares an attribute of unprocessed input information with an attribute of the input value (No in loop end L21, step S42). The input value used for the comparison processing in step S42 is the input value extracted in the input value table 4. The setting unit 52 determines whether the attribute of the unprocessed input information matches the attribute of the input value (step S43). In a case where the attribute of the unprocessed input information does not match the attribute of the input value, processing subsequent to the loop end L21 is repeated (No in step S43).

On the other hand, in a case where the attribute of the unprocessed input information matches the attribute of the input value, the setting unit 52 compares an item number associated with an operation handling component to be an input destination of the unprocessed input information with an item number associated with the input value (Yes in step S43, step S44). In a case where the item number associated with the operation handling component to be the input destination of the input information matches the item number associated with the input value, the setting unit 52 sets the input value to the input information to be processed and returns to the loop end L21 (Yes in step S45, step S46). In a case where the item number associated with the operation handling component does not match the item number associated with the input value, the processing subsequent to the loop end L21 is repeated (No in step S45).

When determined in the loop end L21 that all the input information has been processed regarding the operation handling component to be processed, the setting unit 52 returns to the loop end L11. When determined in the loop end L11 that the processing in the setting loop has been executed on all the operation handling components, the setting unit 52 terminates the processing of the input value table processing loop.

When the processing of the input value table processing loop is terminated, the determination unit 22 reads the parameter of the classifier from the storage unit 40 (step S46). Next, loop processing sandwiched between loop ends L31 and L32 is executed. Hereinafter, there is a case where the loop processing sandwiched between the loop ends L31 and L32 is referred to as an “association loop”. The specifying unit 51 determines whether there is an operation handling component having input information of which an input value has not been determined yet (loop end L31). In a case where there is the operation handling component having the input information of which the input value has not been determined yet, the specifying unit 51 determines the operation handling component to be a target of the input value setting processing (Yes in loop end L31, step S47).

Next, loop processing sandwiched between loop ends L41 and L42 is executed. Hereinafter, there is a case where the loop processing sandwiched between the loop ends L41 and L42 is referred to as a “determination loop”. The specifying unit 51 determines whether attention has been paid to all the set input information of the preceding operation handling component (loop end L41). In a case where there is the set input information of the preceding operation handling component which is not used for the determination processing, the specifying unit 51 selects input information to be used for the determination processing (No in loop end L41, step S48). The input information selected in step S48 is selected from among the set input information of the preceding operation handling component. The specifying unit 51 obtains a distance between the operation handling component to be the target of the setting processing and the preceding operation handling component to be the input destination of the selected input information (step S49). The determination unit 22 determines whether the input value set to the input information which is the setting target of the input value matches the input value set to the input information of the preceding operation handling component according to the distance by using the classifier (step S50). When the determination unit 22 determines that the two input values do not match, the specifying unit 51 returns to the loop end L41 (No in step S51).

On the other hand, in the determination in step S50, it is assumed that the determination unit 22 has determined that the two input values match (Yes in step S51). The setting unit 52 sets the input value set as the input information of the preceding operation handling component to the input information of the operation handling component which is the setting target of the input value (step S52). When the processing in step S52 is executed, the specifying unit 51 exits from the determination loop and returns to the loop end L31.

When it is determined that the attention is paid to all the set input information of the preceding operation handling component in the loop end L41, the specifying unit 51 exits from the determination loop and returns to the loop end L31. When it is determined that there is no operation handling component having the input information of which the input value has not been determined yet in the loop end L31, the specifying unit 51 terminates the processing.

As described above, the generation device 10 according to the embodiment extracts the input value from the operation procedure manual 2 and specifies the attribute of each input value. Therefore, the generation device 10 may associate the input information in the operation design information 5 with the input value by using the attribute of the input value. Regarding the input information (second input information) of which the input value is not determined based on the attribute of the input value, it may be determined whether it is positive in that there is a possibility that the input value of the second input information matches the input value of the other input information (first input information) based on the distance by using the learned model. In a case where the determination result by the determination unit 22 obtained by using the classifier is “match”, the generation device 10 makes the value of the second input information match the input value of the first input information. Therefore, the generation device 10 may set the input value to the input information of which the input value is not determined based on the attribute.

An example in a case where the input value is set to the subsequent operation handling component by using the information of the preceding operation handling component to which the input value has been set has been described with reference to FIGS. 10 to 14B. However, this is merely an example. For example, by processing similar to the processing described with reference to FIGS. 10 to 14B, the generation device 10 may set the input value to the preceding operation handling component by using the information of the subsequent operation handling component to which the input value has been set.

<Generation of Workflow>

The generation unit 34 converts the operation design information 5 to which the setting of the input value has been completed into a workflow. For the conversion processing from the operation design information 5 into the workflow by the generation unit 34, an arbitrary existing method can be used. The output unit 35 outputs the workflow generated by the generation unit 34. An output destination may be other device, and may be a display device (not shown) included in the generation device 10 and the like.

As described above, the generation device 10 may autonomously set the input value to each piece of the input information registered in the operation design information 5. Therefore, the workflow may be automatically generated from the text data of the operation procedure manual 2.

<Example of Hardware Configuration of Generation Device 10>

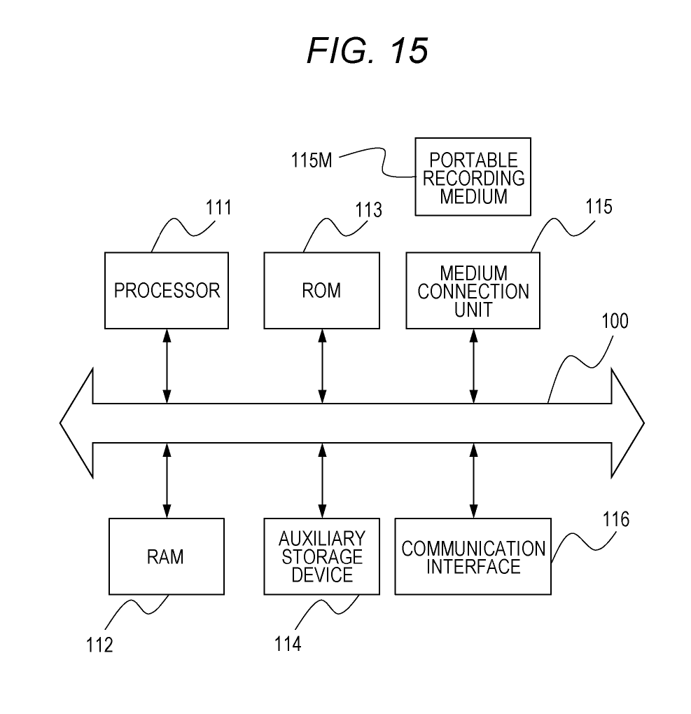

FIG. 15 is a diagram for explaining an example of a hardware configuration of the generation device 10. As illustrated in the example in FIG. 15, a processor 111, a Random Access Memory (RAM) 112, and a Read Only Memory (ROM) 113 are connected to a bus 100. An auxiliary storage device 114, a medium connection unit 115, and a communication interface 116 are connected to the bus 100.

The processor 111 executes a program developed in the RAM 112. As the program to be executed, a program for executing the processing in the embodiment may be applied.

The ROM 113 is a nonvolatile storage device which stores the program developed in the RAM 112. The auxiliary storage device 114 is a storage device which stores various information, and for example, a hard disk drive, a semiconductor memory, and the like may be applied to the auxiliary storage device 114. The medium connection unit 115 is provided to be connectable to a portable recording medium 115M.

As the portable recording medium 115M, a portable memory (for example, semiconductor memory), an optical disc (for example, Compact Disc (CD) and Digital Versatile Disc (DVD)), and the like may be applied. A program for executing the processing in the embodiment may be recorded in the portable recording medium 115M.

The learning processing unit 20 and the creation processing unit 30 described above may be realized by executing a given program by the processor 111. The storage unit 40 may be realized by the RAM 112, the auxiliary storage device 114, and the like.

All of the RAM 112, the ROM 113, the auxiliary storage device 114, and the portable recording medium 115M are examples of computer-readable tangible storage media. These tangible storage media are not temporary media such as a signal carrier.

<Others>

The present embodiment is not limited to the embodiment described above, and various configurations and embodiments can be made without departing from the scope of the present embodiment.

For example, in the above description, the storage unit 40 stores the operation procedure manual database 44. However, the operation procedure manual 2 to be processed may be read by the generation device 10 as appropriate. In a case where the operation procedure manual 2 is read by the generation device 10, the generation device 10 may read the operation procedure manual 2 via the communication interface 116. Furthermore, the generation device 10 may further include an input device (not shown) and obtain the operation procedure manual 2 via the input device.

The learned model may be changed. For example, the learned model may be information obtained by determining whether the input value of the preceding operation handling component matches the input value of the subsequent operation handling component regarding a combination of the identification information of the preceding operation handling component, the identification information of the subsequent operation handling component, and the distance between the operation handling components. For example, in a case where a single input value is set to each operation handling component, with this modification, it is possible to determine whether the input values of the operation handling components match and to set the input value by using the identification information of each operation handling component instead of the ID of the input information.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium recording a generation program for causing a computer to execute processing comprising:
referring to a storage which identifiably stores whether or not an input value is specified for each of a plurality of programs corresponding to a plurality of processing included in a workflow to be created;
specifying a first program in which the input value is specified and a second program in which the input value is not specified from among the plurality of programs;
determining whether or not the input value of the second program is estimated based on the input value of the first program and a positional relation in the workflow between the specified first program and second program; and
setting the input value of the first program as the input value of the second program when determining that the input value of the second program is estimated.

2. The non-transitory computer-readable recording medium according to claim 1, wherein
the determination whether or not the input value of the second program is estimated is made based on a tendency indicating whether or not the input value of the first program matches the input value of the second program for each positional relation between the first program and the second program.

3. The non-transitory computer-readable recording medium according to claim 1, wherein
the determination whether or not the input value of the second program is estimated is made based on a conversion parameter which converts a combination of information indicating the positional relation between the first program and the second program, identification information of the first program, and identification information of the second program into information indicating whether or not the input value of the second program is estimated.

4. The non-transitory computer-readable recording medium according to claim 3, wherein
the conversion parameter is generated by machine learning the positional relation between the plurality of programs and information indicating whether input values of the plurality of programs match.

5. The non-transitory computer-readable recording medium according to claim 1, wherein
the positional relation in the workflow between the first program and the second program is information indicating the number of processing included in the workflow to be created between first processing executed by the first program and second processing executed by the second program.

6. The non-transitory computer-readable recording medium according to claim 1, wherein the processing comprising:
extracting an input value in association with an order of processing in a procedure manual and a data type indicating a type of data from the procedure manual in which the plurality of processing included in the workflow to be created is described; and
setting a value associated with an order same as an order of the processing executed by the first program in the workflow to be created and classified into a data type same as a data type of an input value to the first program of the extracted input values as the input value to the first program.

7. An information processing apparatus comprising:
a memory; and
a processor coupled to the memory and configured to:
refer to a storage which identifiably stores whether or not an input value is specified for each of a plurality of programs corresponding to a plurality of processing included in a workflow to be created;
specify a first program in which the input value is specified and a second program in which the input value is not specified from among the plurality of programs;
determine whether or not the input value of the second program is estimated based on the input value of the first program and a positional relation in the workflow between the specified first program and second program; and
set the input value of the first program as the input value of the second program when determining that the input value of the second program is estimated.

8. The information processing apparatus according to claim 7, wherein
the determination whether or not the input value of the second program is estimated is made based on a tendency indicating whether or not the input value of the first program matches the input value of the second program for each positional relation between the first program and the second program.

9. The information processing apparatus according to claim 7, wherein
the determination whether or not the input value of the second program is estimated is made based on a conversion parameter which converts a combination of information indicating the positional relation between the first program and the second program, identification information of the first program, and identification information of the second program into information indicating whether or not the input value of the second program is estimated.

10. The information processing apparatus according to claim 9, wherein
the conversion parameter is generated by machine learning the positional relation between the plurality of programs and information indicating whether input values of the plurality of programs match.

11. The information processing apparatus according to claim 7, wherein
the positional relation in the workflow between the first program and the second program is information indicating the number of processing included in the workflow to be created between first processing executed by the first program and second processing executed by the second program.

12. The information processing apparatus according to claim 7, wherein the processor is configured to:
extract an input value in association with an order of processing in a procedure manual and a data type indicating a type of data from the procedure manual in which the plurality of processing included in the workflow to be created is described; and
set a value associated with an order same as an order of the processing executed by the first program in the workflow to be created and classified into a data type same as a data type of an input value to the first program of the extracted input values as the input value to the first program.

13. A generation method comprising:
referring, by a computer, to a storage which identifiably stores whether or not an input value is specified for each of a plurality of programs corresponding to a plurality of processing included in a workflow to be created;
specifying a first program in which the input value is specified and a second program in which the input value is not specified from among the plurality of programs;
determining whether or not the input value of the second program is estimated based on the input value of the first program and a positional relation in the workflow between the specified first program and second program; and
setting the input value of the first program as the input value of the second program when determining that the input value of the second program is estimated.

14. The generation method according to claim 13, wherein
the determination whether or not the input value of the second program is estimated is made based on a tendency indicating whether or not the input value of the first program matches the input value of the second program for each positional relation between the first program and the second program.

15. The generation method according to claim 13, wherein
the determination whether or not the input value of the second program is estimated is made based on a conversion parameter which converts a combination of information indicating the positional relation between the first program and the second program, identification information of the first program, and identification information of the second program into information indicating whether or not the input value of the second program is estimated.

16. The generation method according to claim 15, wherein
the conversion parameter is generated by machine learning the positional relation between the plurality of programs and information indicating whether input values of the plurality of programs match.

17. The generation method according to claim 13, wherein
the positional relation in the workflow between the first program and the second program is information indicating the number of processing included in the workflow to be created between first processing executed by the first program and second processing executed by the second program.

18. The generation method according to claim 13, further comprising:
extracting an input value in association with an order of processing in a procedure manual and a data type indicating a type of data from the procedure manual in which the plurality of processing included in the workflow to be created is described; and
setting a value associated with an order same as an order of the processing executed by the first program in the workflow to be created and classified into a data type same as a data type of an input value to the first program of the extracted input values as the input value to the first program.
